(19) United States
(12) Patent Application Publication
(10) Pub. No.: US 2016/0230744 A1
(43) Pub. Date: Aug. 11, 2016

(54) WIND TURBINE WITH DUAL BLADE ASSEMBLIES

(71) Applicants: Calvin Boyle, Cleveland, OH (US); Ross Manganaro, Pittsburgh, PA (US); Paul Novelli, Pittsburgh, PA (US); Kyle Hicken, Alliance, OH (US); Tyler Frank, Erie, PA (US); Brandon Robinson, Johnstown, PA (US)

(72) Inventors: Calvin Boyle, Cleveland, OH (US); Ross Manganaro, Pittsburgh, PA (US); Paul Novelli, Pittsburgh, PA (US); Kyle Hicken, Alliance, OH (US); Tyler Frank, Erie, PA (US); Brandon Robinson, Johnstown, PA (US)

(21) Appl. No.: 14/619,654

(22) Filed: Feb. 11, 2015

(51) Int. Cl. F03D 11/00; H02K 16/00; H02K 7/18; F03D 1/02; F03D 9/00

(52) U.S. Cl. CPC F03D 11/0058; F03D 1/025; F03D 9/002; H02K 7/1838; H02K 16/005; F03D 11/0008

(57) ABSTRACT

A wind turbine including a housing, an electrical generation unit including a field magnet and an armature, the electrical generation unit being rotatably disposed within the housing, a first blade assembly non-rotatably fixed to one of the field magnet and the armature of the electrical generation unit, and a second blade assembly non-rotatably fixed to the other of the field magnet and the armature of the electrical generation unit, wherein the first blade assembly rotates in a first direction with respect to the housing and the second blade assembly rotates in an opposite second direction with respect to the housing.

### FIELD OF THE INVENTION

The present invention relates generally to wind turbines. More particularly, the present invention relates to a wind turbine having a pair of blade assemblies that rotate independently of each other.

### BACKGROUND OF THE INVENTION

Green energy trends have been on the rise in recent years and, subsequently, so has the demand for consumer grade wind turbines for harvesting wind energy. Specifically, interest in wind turbines that can be utilized to provide power for individual homes and small businesses has increased greatly over recent years. However, individual home and business owners often face challenges that operators of large scale “wind farms” typically do not encounter. For example, because the wind turbine is necessarily located at the home or business to which energy is supplied, the amount of space that is available to operate the wind turbine may be limited. As well, the environmental conditions at the desired location may not provide the wind speeds that are required for efficient and reliable operation of traditional wind turbines. For example, the prevailing wind speeds of the desired location may be lower than the target wind speeds required for turbine cut-in with traditional wind turbines, cut-in referring to the wind speed at which the turbine blades begin to rotate and, therefore, generate energy. As well, low wind speeds are known to reduce the ability of existing wind turbines to approach the 59.3% limit of converting wind energy to electrical energy suggested by the Betz Limit.

The present invention recognizes and addresses considerations of prior art constructions and methods.

### SUMMARY OF THE INVENTION

One embodiment of the present disclosure provides a wind turbine having a housing, a generator including a field magnet and an armature, the generator being rotatably disposed within the housing, a first blade assembly non-rotatably fixed to one of the field magnet and the armature of the generator, and a second blade assembly non-rotatably fixed to the other of the field magnet and the armature of the generator, wherein the first blade assembly rotates in a first direction with respect to the housing and the second blade assembly rotates in an opposite second direction with respect to the housing.

Another embodiment of the present disclosure provides a wind turbine having a housing, an electrical generation unit including a field magnet and an armature, the electrical generation unit being rotatably disposed within the housing, a first blade assembly non-rotatably fixed to one of the field magnet and the armature of the electrical generation unit, and a second blade assembly non-rotatably fixed to the other of the field magnet and the armature of the electrical generation unit.

Yet another embodiment of the present disclosure provides a wind turbine having a housing, an electrical generation unit including a field magnet and an armature, the field magnet and the armature each being rotatably disposed within the housing, a first blade assembly fixed to one of the field magnet and the armature of the electrical generation unit, and a second blade assembly fixed to the other of the field magnet and the armature of the electrical generation unit, wherein the field magnet and the armature are rotatable independently of each other.

The accompanying drawings, which are incorporated in and constitute a part of this specification, illustrate one or more embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended drawings, in which:

FIG. 1 is a perspective view of a wind turbine including a pair of blade assemblies in accordance with the present disclosure;

FIG. 2 is a front view of the wind turbine shown in FIG. 1;

FIG. 3 is a side view of the wind turbine shown in FIG. 1;

FIG. 4 is a partial, exploded view of the wind turbine as shown in FIG. 1;

FIG. 5 is a cutaway, partial perspective view of the wind turbine shown in FIG. 1; and

FIGS. 6A and 6B are schematic diagrams of the wind turbine shown in FIG. 1.

Repeat use of reference characters in the present specification and drawings is intended to represent same or analogous features or elements of the invention according to the disclosure.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation, not limitation, of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

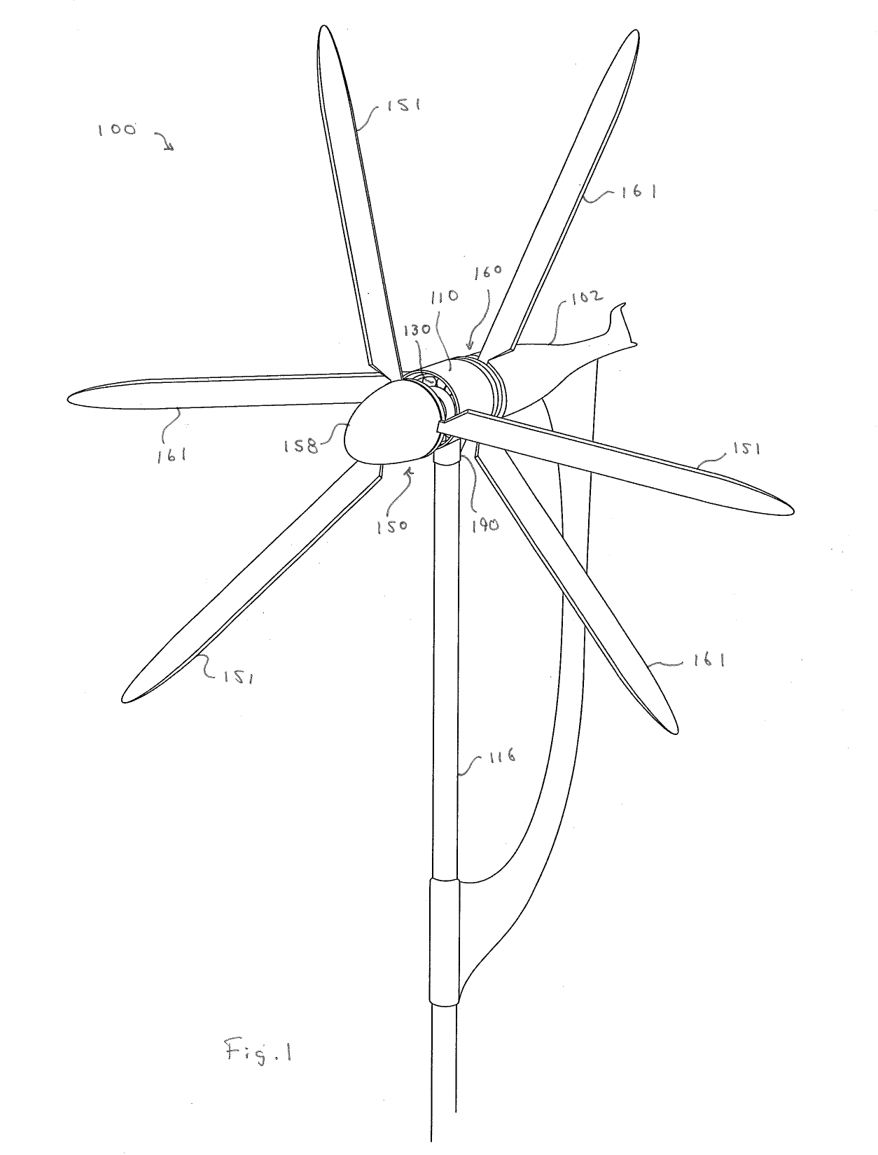

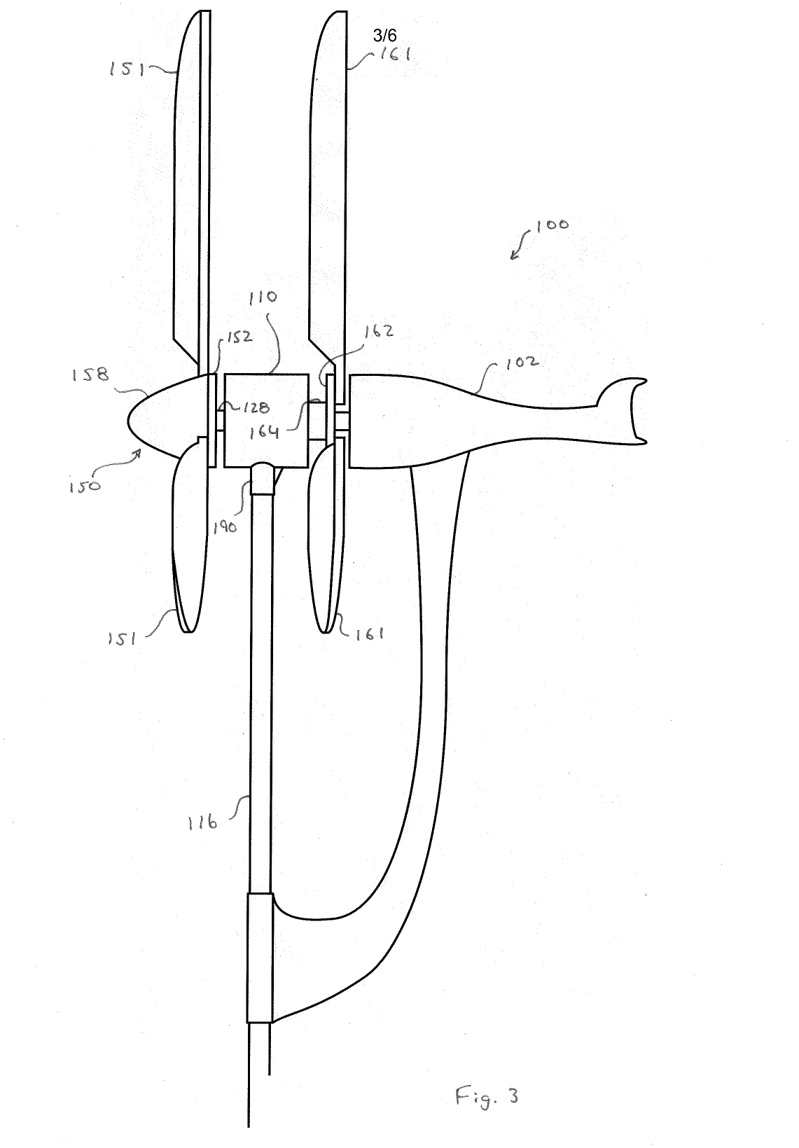

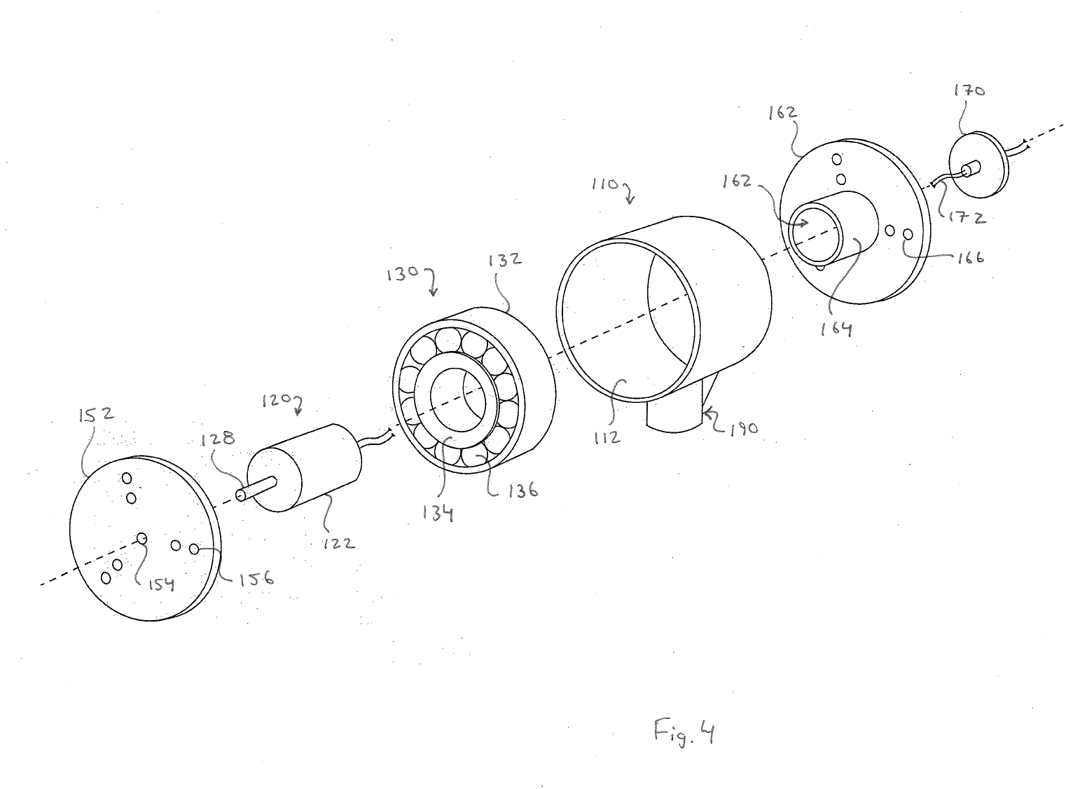

Referring now to FIGS. 1 through 3, a wind turbine assembly 100 in accordance with an embodiment of the present disclosure is shown. As shown, wind turbine assembly 100 includes a front blade assembly 150 that extends forwardly of a housing 110 of wind turbine assembly 100 and a rear blade assembly 160 which extends rearwardly of housing 110. Housing 110 is pivotably secured to a tower 116 that extends upwardly from a corresponding support surface (not shown), housing 110 defining an interior compartment in which an electrical generation unit 120 (FIG. 4) is disposed, as discussed in greater detail below. A yaw control mechanism 190 is disposed between housing 110 of wind turbine assembly 100 and tower 116, which allows the wind turbine assembly to be pointed in the direction of the prevailing winds, as is commonly known in the art. A nacelle 102 is disposed aft of rear blade assembly 160 to provide improved aerodynamics for wind turbine assembly 100.

Referring additionally to FIG. 4, front blade assembly 150 includes a central hub 152 from which a plurality of blades 151 radially extend, each blade 151 being secured to hub 152 by way of fasteners (not shown) passing through corresponding blade recesses 156. Preferably, the pitch of each blade 151 may be altered, as is known in the art, to maximize the speed of rotation of front blade assembly 150 for the prevailing wind speed. Hub 152 further defines a central shaft aperture 154 that is configured to be non-rotatably secured to a drive shaft 128 of electrical generation unit 120. Front blade assembly 150 further includes a nose cone 158 that is secured to hub 152 to improve the aerodynamic performance of wind turbine assembly 100.

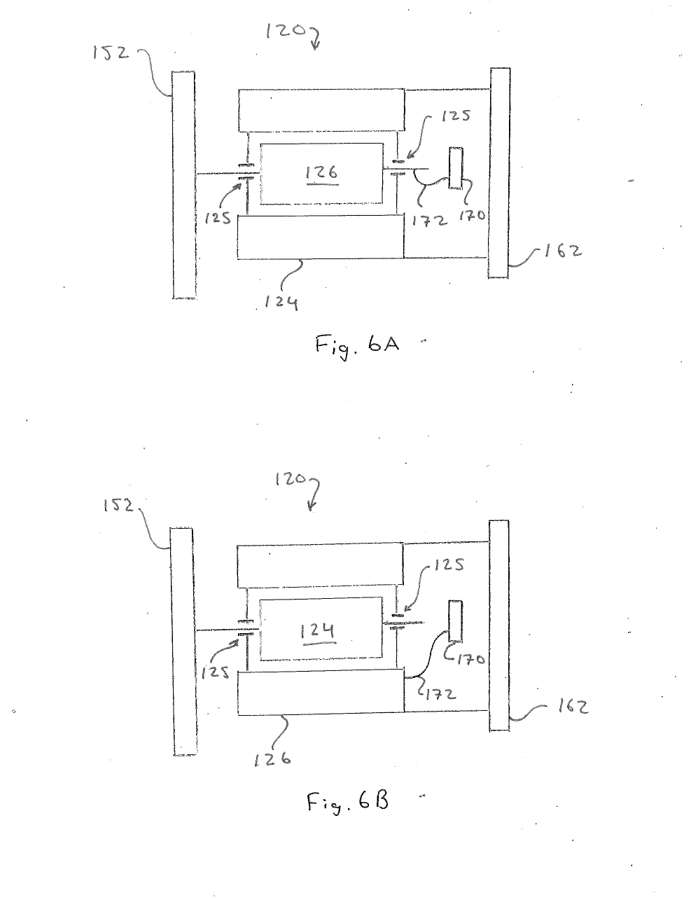

Similarly to front blade assembly 150, rear blade assembly 160 includes a plurality of blades 161 that extend radially outwardly from its hub 162. Additionally, each blade 161 is secured to hub 162 by a plurality of fasteners (not shown) that pass through corresponding blade recesses 166. As with front blade assembly, the pitch of each blade 161 may be altered, as is known in the art, to maximize the speed of rotation of front blade assembly 160 for the prevailing wind speed. Hub 162 further includes an axially extending annular wall 164 that is non-rotatably fixed to a body 122 of electrical generation unit 120. As such, in the preferred embodiment shown, rear blade assembly 160 is non-rotatably fixed to the magnetic portion, or field magnet 124, of electrical generation unit 120, whereas front blade assembly 150 is non-rotatably fixed to the windings, or armature 126, of electrical generation unit 120, as best seen in FIG. 6A. In short, armature 126 of electrical generation unit 120 is rotatably supported within body 122, which defines field magnet 124 of generation unit. Alternately, as shown in FIG. 6B, field magnet 124 may be non-rotatably fixed to front blade assembly 150 and rotatably supported within armature 126, which is defined by body 122 of the electrical generation unit 120. In both instances, radial bearings 125 are provided to rotatably support either field magnet 124 or armature 126 within the other of the electrical components.

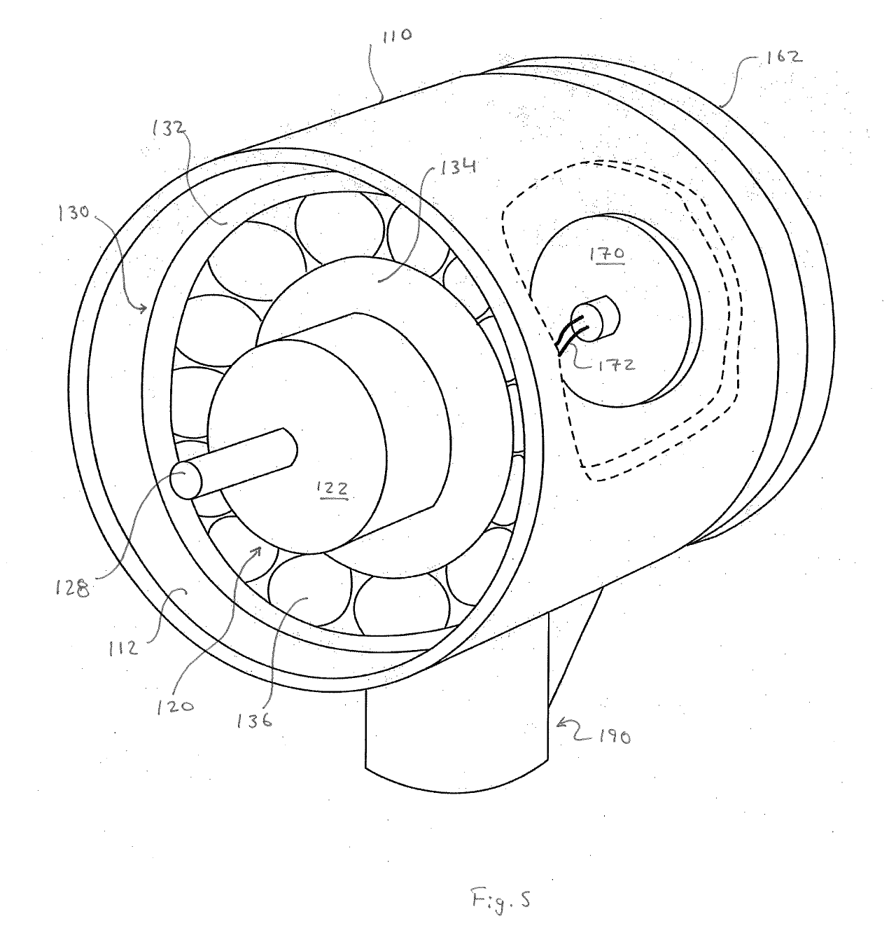

As best seen in FIGS. 4 and 5, a radial bearing assembly 130 is provided to rotatably support electrical generation unit 120 within housing 110 of wind turbine assembly 100. Radial bearing assembly 130 includes an outer race 132, an inner race 134 and a plurality of either ball bearings or needle bearings 136 disposed therebetween. Outer race 132 is non-rotatably secured to an inner surface 112 of the wind turbine housing 110, whereas body 122 of electrical generation unit 120 is non-rotatably secured to an inner surface 135 of inner race 134 of the radial bearing assembly 130. As such, the entire electrical generation unit 120 is rotatably disposed within housing 110 of wind turbine assembly 100. Moreover, front blade assembly 150 and rear blade assembly 160 are rotatable with respect to each other, as well as housing 110 of wind turbine assembly 100. As such, because front blade assembly 150 and rear blade assembly 160 counter-rotate with respect to each other, the revolutions per minute (RPM) of field magnet 124 with respect to armature 126 is effectively doubled as compared to a traditional wind turbine in which one of the armature or the field magnet is non-rotatable with respect to the housing of the wind turbine. Moreover, by providing increased RPM between the armature and the field magnet as compared to traditional wind turbines for the same wind speeds, the sizes of blades 151 and 161 may be reduced as compared to the blades of known wind turbines. Reduced size leads to reduced mass which, in turn, leads to lower cut-in wind speeds for wind turbine 100 as compared to traditional wind turbines.

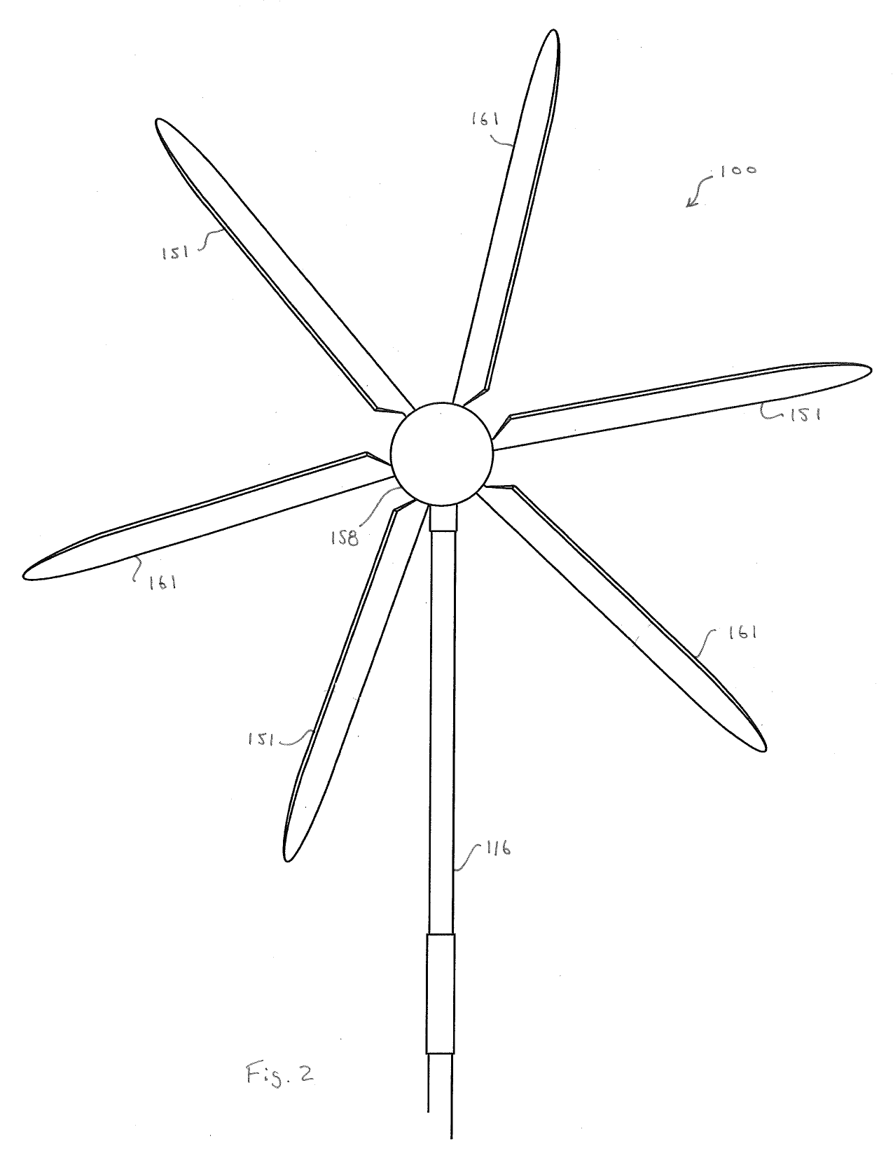

As best seen in FIG. 2, the pitch of blades 151 of front blade assembly 150 is selected so that front blade assembly 150 rotates in the counter-clockwise (CCW) direction, whereas the pitch of blades 161 of rear blade assembly 160 is selected such that rear blade assembly 160 rotates in the clockwise (CW) direction. Note, however, in an alternate embodiment, front blade assembly 150 may be selected to rotate in the CW direction whereas rear blade assembly 160 is selected to rotate in the CCW direction. As best seen in FIGS. 6A and 6B, a slip ring 170 including wire leads 172 is utilized to remove electrical power from armature 126 regardless of whether armature 126 is driven by front blade assembly 150 (FIG. 6A) or rear blade assembly 160 (FIG. 6B).

While one or more preferred embodiments of the invention are described above, it should be appreciated by those skilled in the art that various modifications and variations can be made in the present invention without departing from the scope and spirit thereof. It is intended that the present invention cover such modifications and variations as come within the scope and spirit of the appended claims and their equivalents.

What is claimed is:

1. A wind turbine, comprising:
a housing;
a generator including a field magnet and an armature, the generator being rotatably disposed within the housing;
a first blade assembly non-rotatably fixed to one of the field magnet and the armature of the generator; and
a second blade assembly non-rotatably fixed to the other of the field magnet and the armature of the generator,
wherein the first blade assembly rotates in a first direction with respect to the housing and the second blade assembly rotates in an opposite second direction with respect to the housing.

2. The wind turbine of claim 1, further comprising a radial bearing assembly including an outer race non-rotatably fixed to an inner surface of the housing, an inner race non-rotatably fixed to an outer surface of the generator, and a plurality of roller elements in rolling contact with, and disposed between, the inner race and the outer race of the radial bearing assembly.

3. The wind turbine of claim 2, wherein the plurality of roller elements is a plurality of ball roller elements.

4. The wind turbine of claim 2, wherein the plurality of roller elements is a plurality of cylindrical roller elements.

5. The wind turbine of claim 1, wherein the first blade assembly is non-rotatably fixed to the field magnet of the generator and the second blade assembly is non-rotatably fixed to the armature of the generator.

6. The wind turbine of claim 1, further comprising a slip ring that is in electrical communication with the generator.

7. The wind turbine of claim 1, wherein the first blade assembly includes a hub and a plurality of turbine blades extending radially outwardly therefrom, and the second blade assembly includes a hub and a plurality of turbine blades extending radially outwardly therefrom.

8. The wind turbine of claim 7, wherein the plurality of turbine blades of the first blade assembly includes at least three turbine blades, and the plurality of turbine blades of the second blade assembly includes at least three turbine blades.

9. The wind turbine of claim 1, further comprising a tower extending radially outwardly from the housing such that the tower supports the housing above a support surface.

10. A wind turbine, comprising:
a housing;
an electrical generation unit including a field magnet and an armature, the electrical generation unit being rotatably disposed within the housing;
a first blade assembly non-rotatably fixed to one of the field magnet and the armature of the electrical generation unit; and
a second blade assembly non-rotatably fixed to the other of the field magnet and the armature of the electrical generation unit.

11. The wind turbine of claim 10, wherein the first blade assembly rotates in a first direction with respect to the housing and the second blade assembly rotates in an opposite second direction with respect to the housing.

12. The wind turbine of claim 10, further comprising a radial bearing assembly including an outer race non-rotatably fixed to an inner surface of the housing, an inner race non-rotatably fixed to an outer surface of the electrical generation unit, and a plurality of roller elements in rolling contact with, and disposed between, the inner race and the outer race of the radial bearing assembly.

13. The wind turbine of claim 12, wherein the plurality of roller elements is a plurality of ball roller elements.

14. The wind turbine of claim 12, wherein the plurality of roller elements is a plurality of cylindrical roller elements.

15. The wind turbine of claim 10, wherein the electrical generation unit is a generator.

16. The wind turbine of claim 10, wherein the electrical generation unit is an alternator.

17. The wind turbine of claim 10, wherein the first blade assembly is non-rotatably fixed to the field magnet of the electrical generation unit and the second blade assembly is non-rotatably fixed to the armature of the electrical generation unit.

18. The wind turbine of claim 10, further comprising a slip ring that is in electrical communication with the electrical generation unit.

19. A wind turbine, comprising:
a housing;
an electrical generation unit including a field magnet and an armature, the field magnet and the armature each being rotatably disposed within the housing;
a first blade assembly fixed to one of the field magnet and the armature of the electrical generation unit; and
a second blade assembly fixed to the other of the field magnet and the armature of the electrical generation unit,
wherein the field magnet and the armature are rotatable independently of each other.

20. The wind turbine of claim 19, wherein the first blade assembly is non-rotatably fixed to one of the field magnet of the generator, the second blade assembly is non-rotatably fixed to the other of the armature of the generator, and the first blade assembly is rotatable in a first direction with respect to the housing whereas the second blade assembly is rotatable with respect to the housing in an opposite second direction.
